(19) United States
(12) Patent Application Publication
(10) Pub. No.: US 2025/0176501 A1
(43) Pub. Date: Jun. 5, 2025

(54) INTERACTIVE DISPLAY SYSTEM FOR DOG, METHOD OF OPERATING THE SAME AND INTERACTIVE DISPLAY APPARATUS FOR DOG

(71) Applicant: SUNNY WAVE TECH CO., LTD., Ulsan (KR)

(72) Inventors: Bonghyun YOU, Seoul (KR); Tami KIM, Seoul (KR)

(73) Assignee: SUNNY WAVE TECH CO., LTD., Ulsan (KR)

(21) Appl. No.: 18/841,171

(22) PCT Filed: Feb. 22, 2023
(86) PCT No.: PCT/KR2023/002564

§ 371 Date: Aug. 23, 2024

(30) Foreign Application Priority Data
Feb. 28, 2022 (KR) 10-2022-0026362

(51) Int. Cl. A01K 29/00; G06F 3/01; G06V 20/50; G06V 40/00

(52) U.S. Cl. CPC A01K 29/005; G06F 3/013; G06V 20/50; G06V 40/00

(57) ABSTRACT

An interactive display system for a dog includes a display module, a sensor and a controller. The display module displays an image. The sensor is senses the dog's condition. The controller determines at least one of the dog's approach, whether the dog views a video and the dog's emotion based on sensed data of the sensor and controls an operation of the interactive display system.

### TECHNICAL FIELD

The present inventive concept relates to an interactive display system for a dog, a method of operating the interactive display system and an interactive display apparatus for a dog. More particularly, the present inventive concept relates to an interactive display system for a dog controlling an operation of a display apparatus for a dog by determining at least one of whether the dog is approaching, whether the dog is viewing a video, the dog's emotion, the dog's sound or movement and the dog's health information, a method of operating the interactive display system and an interactive display apparatus for a dog.

### BACKGROUND

As the number of people raising dogs increases and public interest in dogs increases, a display apparatus for dogs are being developed. In a conventional display apparatus for dogs, a dog owner selects a video and provides the video unilaterally so that the dog may lose interest in the video.

In addition, if the dog owner goes out or leaves the display apparatus while the display apparatus is turned on, the video may continue to be played even if the dog does not watch the video at all or even if the dog experiences negative emotions through the video.

### DETAILED EXPLANATION OF THE INVENTION

### Technical Purpose

The purpose of the present inventive concept is providing an interactive display system for a dog controlling an operation of a display apparatus for a dog by determining at least one of whether the dog is approaching, whether the dog is viewing a video, the dog's emotion, the dog's sound or movement and the dog's health information.

The purpose of the present inventive concept is providing a method of operating the interactive display system for a dog.

The purpose of the present inventive concept is providing an interactive display apparatus for a dog.

### Technical Solution

In an example interactive display system for a dog according to the present inventive concept to achieve the purpose of the present inventive concept, the interactive display system includes a display module, a sensor and a controller. The display module displays an image. The sensor is senses the dog's condition. The controller determines at least one of the dog's approach, whether the dog views a video and the dog's emotion based on sensed data of the sensor and controls an operation of the interactive display system.

In an embodiment of the present inventive concept, the controller may include an object identifier which identifies an object based on the sensed data.

In an embodiment of the present inventive concept, the sensor may include a camera which senses an appearance of the dog. The object identifier may identify the object based on at least one of a color of the dog, shapes of the dog's ears, eyes, mouth and nose and positions of the dog's ears, eyes, mouth and nose.

In an embodiment of the present inventive concept, the controller may vary contents displayed on the display module according to the object.

In an embodiment of the present inventive concept, the object identifier may identify the dog's breed and age.

In an embodiment of the present inventive concept, the controller may vary contents displayed on the display module based on the dog's breed and age.

In an embodiment of the present inventive concept, the sensor may include a proximity sensor. The controller may include an approaching determiner which determines the dog's approach based on data of the proximity sensor.

In an embodiment of the present inventive concept, when a distance between the dog and the display module is less than a first distance for equal to or greater than a first time, the approaching determiner may determine the dog's approach. When the distance between the dog and the display module is greater than a second distance which is greater than the first distance for equal to or greater than a second time which is greater than the first time, the approaching determiner may determine that the dog leaves.

In an embodiment of the present inventive concept, the sensor may include a camera. The controller may include a viewing determiner which determines whether the dog views the video or not based on data of the camera.

In an embodiment of the present inventive concept, the viewing determiner may set a region of interest at positions of eyes of the dog and operates an eye tracking based on the region of interest.

In an embodiment of the present inventive concept, the controller may further include an emotion recognizer which determines the dog's emotion based on the data of the camera.

In an embodiment of the present inventive concept, the sensor may further include a microphone. The emotion recognizer may determine the dog's emotion based on the data of the camera and data of the microphone.

In an embodiment of the present inventive concept, the emotion recognizer may determine the dog's positive emotion and the dog's negative emotion using movements of the dog's ears and movements of the dog's facial muscles.

In an embodiment of the present inventive concept, the emotion recognizer may determine the dog's positive emotion and the dog's negative emotion using angles of the dog's ears, eyes, mouth and nose and shapes of eyes.

In an embodiment of the present inventive concept, when the approaching determiner determines that the dog is in a predetermined distance, the viewing determiner determines that the dog is viewing the video and the emotion recognizer determines the dog's positive emotion, the controller may control the display module to display the video continuously.

In an embodiment of the present inventive concept, when the approaching determiner determines that the dog is in the predetermined distance, the viewing determiner determines that the dog is viewing the video and the emotion recognizer determines the dog's positive emotion, the controller may send a notification message to a dog owner's mobile apparatus notifying that the dog is viewing the video with the positive emotion.

In an embodiment of the present inventive concept, the emotion recognizer may determine a degree of the dog's fatigue based on a degree of the dog's eyelid closure and a degree of the dog's mouth opening.

In an embodiment of the present inventive concept, when the approaching determiner determines that the dog is in a predetermined distance, the viewing determiner determines that the dog is viewing the video and the emotion recognizer determines that the degree of the dog's fatigue is equal to or greater than a reference value, the controller may control to turn off the display module or to change a content of the display module.

In an embodiment of the present inventive concept, when the approaching determiner determines that the dog is in a predetermined distance and the emotion recognizer determines the dog's negative emotion, the controller may control the display module to display a photo or a video of a dog owner.

In an embodiment of the present inventive concept, when the approaching determiner determines that the dog is in a predetermined distance and the emotion recognizer determines the dog's negative emotion, the controller may control to change a content of the display module.

In an embodiment of the present inventive concept, when the approaching determiner determines that the dog is in a predetermined distance and the emotion recognizer determines the dog's negative emotion, the controller may send a notification message to a dog owner's mobile apparatus notifying that the dog has the negative emotion.

In an embodiment of the present inventive concept, the interactive display system for a dog may further include a memory which stores a content displayed on the display module by tagging the dog's emotion for the content.

In an embodiment of the present inventive concept, when the approaching determiner determines that the dog is in a predetermined distance and the viewing determiner determines that the dog is not viewing the video, the controller may control to change a content of the display module.

In an embodiment of the present inventive concept, when the approaching determiner determines that the dog is not in a predetermined distance and the viewing determiner determines that the dog is not viewing the video, the controller may control to turn off the display module.

In an embodiment of the present inventive concept, the interactive display system for a dog may further include a memory which stores a content displayed on the display module by tagging the dog's viewing status for the content.

In an embodiment of the present inventive concept, when the approaching determiner determines that the dog is in a predetermined distance while the display module is turned off, the controller may control to turn on the display module.

In an embodiment of the present inventive concept, the sensor may include a shock sensor. When the shock sensor detects a shock, the controller may send a notification message to a dog owner notifying a shock detection.

In an embodiment of the present inventive concept, the sensor may include a microphone. When the controller recognizes that a barking sound or a howling sound is repeated multiple times by the microphone, the controller may control to play a whistle sound or play a calming content.

In an embodiment of the present inventive concept, the sensor may include a microphone. When the controller recognizes that a barking sound or a howling sound is repeated multiple times by the microphone, the controller may send a sound generation notification message to a dog owner's mobile apparatus.

In an embodiment of the present inventive concept, the display module and the sensor may be included in a display apparatus. The sensor may be an internal sensor of the display apparatus. The sensor may include a camera, a proximity sensor and a microphone.

In an embodiment of the present inventive concept, the display module may be included in a display apparatus. The sensor may be an external sensor disposed outside the display apparatus.

In an embodiment of the present inventive concept, the external sensor may be disposed in at least one of a laptop computer, a personal computer, an internet television and a closed circuit camera system.

In an example method of driving an interactive display system for a dog according to the present inventive concept to achieve the purpose of the present inventive concept, the method includes displaying an image, sensing the dog's condition and controlling an operation of the interactive display system using at least one of the dog's approach, whether the dog views the video and the dog's emotion determined based on sensed data of a sensor.

In an example interactive display apparatus for a dog according to the present inventive concept to achieve the purpose of the present inventive concept, the display apparatus includes a display module, a sensor and a controller. The controller determines at least one of the dog's approach, whether the dog views a video and the dog's emotion based on sensed data of the sensor and which controls an operation of the display module.

### Effect of the Invention

According to the above mentioned interactive display system for a dog, the method of operating the interactive display system and the interactive display apparatus for a dog, the operation of the display system may be controlled according to the dog's approach to the display module. In addition, the operation of the display system may be controlled according to whether the dog views the video on the display module. In addition, the operation of the display system may be controlled according to the change of the dog's emotion in response to the displayed video.

In addition, the display system may be controlled based on the dog's approach, whether the dog views the video, or the dog's emotion so that the dog's concentration may be increased and a power consumption of the display system may be reduced.

In addition, a notification may be sent to the dog owner's mobile apparatus based on the dog's approach, whether the dog views the video, the dog's emotion or the dog's barking sound so that the dog owner may remotely control the display system based on the notification.

In addition, the object may be identified so that the customized content according to the object (e.g. a dog's breed) may be provided.

In addition, whether the dog views the video and the dog's emotion for the content displayed on the display module may be stored in the memory and used for subsequent content recommendations.

### BRIEF EXPLANATION OF THE DRAWINGS

FIG. 1 is a diagram illustrating an example in which an interactive display apparatus for a dog according to an embodiment of the present inventive concept is used.

FIG. 2 is a block diagram illustrating an interactive display system for a dog according to an embodiment of the present inventive concept.

FIG. 3 is a block diagram illustrating a display apparatus for a dog of FIG. 2.

FIG. 4 is a block diagram illustrating a control apparatus of FIG. 2.

FIG. 5 is a conceptual diagram illustrating an operation of an object identifier of FIG. 4.

FIG. 6 is a block diagram illustrating an external sensor of FIG. 2.

FIG. 7 is a table illustrating an example of an operation of the interactive display system for a dog of FIG. 2.

FIG. 8 is a flowchart diagram illustrating an example of an operation sequence of the interactive display system for a dog of FIG. 2.

FIG. 9 is a block diagram illustrating an interactive display apparatus for a dog according to an embodiment of the present inventive concept.

### BEST MODE FOR CARRYING OUT THE INVENTION

The present inventive concept now will be described more fully hereinafter with reference to the accompanying drawings, in which exemplary embodiments of the present invention are shown. The present inventive concept may, however, be embodied in many different forms and should not be construed as limited to the exemplary embodiments set forth herein.

Rather, these exemplary embodiments are provided so that this disclosure will be thorough and complete, and will fully convey the scope of the present invention to those skilled in the art.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

It will be understood that when an element or layer is referred to as being “connected to” or “coupled to” another element or layer, it can be directly connected or coupled to the other element or layer or intervening elements or layers may be present. In contrast, when it is referred that an element is “directly connected to” or “directly coupled to” another element or layer, there are no intervening elements or layers present. Other expressions describing the relationship between elements, such as “between” and “directly between” or “adjacent to” and “directly adjacent to”, etc., should be interpreted similarly. Like numerals refer to like elements throughout. As used herein, the term “and/or” includes any and all combinations of one or more of the associated listed items.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the inventive concept as used herein.

Hereinafter, preferred embodiments of the present inventive concept will be explained in detail with reference to the accompanying drawings. The same reference numerals are used for the same elements in the drawings, and duplicate explanations for the same elements may be omitted.

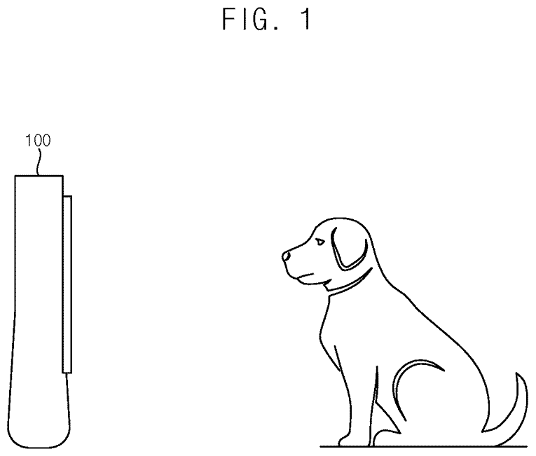

FIG. 1 is a diagram illustrating an example in which an interactive display apparatus 100 for a dog according to an embodiment of the present inventive concept is used.

Referring to FIG. 1, the interactive display apparatus 100 for a dog is a display apparatus used by a dog, and may be installed at a location (or a height) that is convenient for a dog to view. For example, the interactive display apparatus 100 for a dog may display images based on image data considering visual characteristics of dogs. The interactive display apparatus 100 for a dog displays images based on the image data considering the visual characteristics of dogs so that a concentration of a dog for the image may be enhanced.

For example, the interactive display apparatus 100 for a dog may operate at least one of a color compensation, a contrast compensation, a gamma compensation, an edge compensation, a luminance compensation and a driving frequency conversion of input image data to correspond to the visual characteristics of dogs.

For example, the interactive display apparatus 100 for a dog may receive the input image data, may operate the color compensation and may output output image data.

Dogs may distinguish colors through a combination of blue and yellow (dogs may recognize red and green as yellow) and may easily distinguish colors close to an ultraviolet ray. In other words, dogs may more easily distinguish colors in a blue range than humans. Thus, the interactive display apparatus 100 for a dog may generate the output image data in which a ratio of blue among red, green and blue is increased compared to the input image data.

In addition, the interactive display apparatus 100 for a dog may operate the contrast compensation, the gamma compensation, the edge compensation and the driving frequency conversion of the input image data corresponding to the visual characteristics of dogs so that dog's concentration while watching a video may be increased.

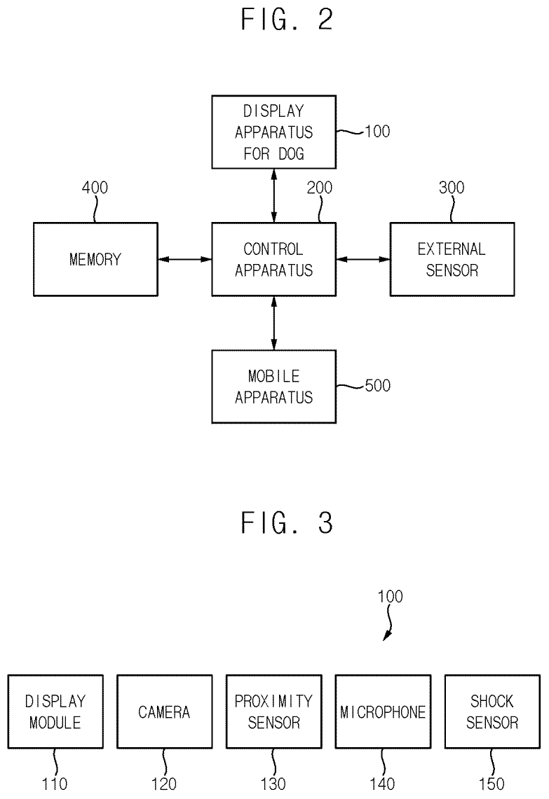

FIG. 2 is a block diagram illustrating an interactive display system for a dog according to an embodiment of the present inventive concept.

Referring to FIGS. 1 and 2, the interactive display system for a dog may include the interactive display apparatus 100 for a dog. The interactive display system for a dog may include the display apparatus 100 for a dog, a control apparatus 200, an external sensor 300 and a memory 400. The interactive display system for a dog may further include a mobile apparatus 500 carried by a dog owner.

The control apparatus 200 may send a notification message to the mobile apparatus 500 of the dog owner. The dog owner may remotely control the interactive display system for a dog using the mobile apparatus 500. For example, the mobile apparatus 500 may operate a video call function using the display module 110.

In the present disclosure, a term of the control apparatus and a term of a controller may be used interchangeably. In the present disclosure, a term of sensor may refer to an internal sensor disposed in the display apparatus 100 for a dog or refer to an external sensor 300 disposed outside the display apparatus 100 for a dog.

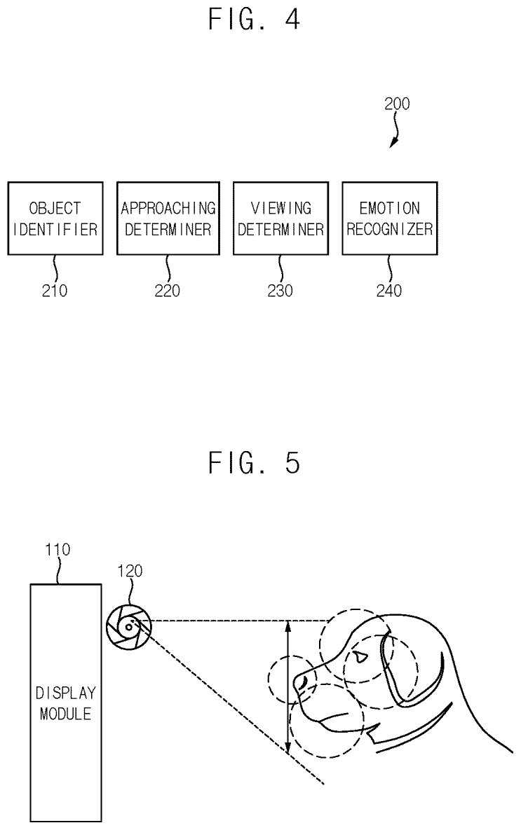

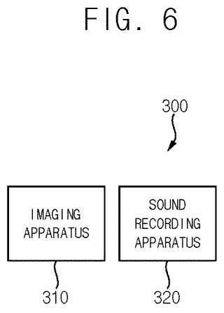

FIG. 3 is a block diagram illustrating the display apparatus 100 for a dog of FIG. 2. FIG. 4 is a block diagram illustrating the control apparatus 200 of FIG. 2. FIG. 5 is a conceptual diagram illustrating an operation of an object identifier 210 of FIG. 4. FIG. 6 is a block diagram illustrating the external sensor 300 of FIG. 2.

Referring to FIGS. 1 to 6, the interactive display system for a dog includes a display module 110 displaying an image, a sensor 120, 130, 140 and 150 sensing a dog's condition and a controller 200 determining at least one of the dog's approach, whether the dog views the video and the dog's emotion based on sensed data of the sensor 120, 130, 140 and 150 and controlling an operation of the system.

The sensor may include a camera 120, a proximity sensor 130 and a microphone 140. The sensor may further include a shock sensor 150.

The controller 200 may include an object identifier 210 identifying an object based on the sensed data.

The object identifier 210 may determine a color of the dog, shapes of the dog's ears, eyes, mouth and nose and positions of the dog's ears, eyes, mouth and nose using the sensed data by the camera 120. The object identifier 210 may identify the object (the dog's breed) based on at least one of the color of the dog, the shapes of the dog's ears, eyes, mouth and nose and the positions of the dog's ears, eyes, mouth and nose.

As shown in FIG. 4, the object identifier 210 may identify the object (the dog's breed) based on the positions and the shapes of the dog's eyes, the position and the shape of the dog's nose and the position and the shape of the dog's mouth which are sensed by the camera 120. For example, the object identifier 210 may identify the object (the dog's breed) based on the dog's nose print sensed by the camera 120.

For example, the object identifier 210 may identify the object using artificial intelligence algorithms such as a machine learning, a deep learning and so on. For example, the dog's breed information, age information, gender information, etc. are learned based on the dog image. And then, when the dog is recognized by the camera 120, the object identifier 210 may automatically identify the dog's object information (e.g. the dog's breed information).

When two dogs (e.g. DOG1 and DOG2) use the interactive display system for a dog, the object identifier 210 may identify whether the dog recognized by the camera 120 of the display apparatus 100 for a dog is DOG1 or DOG2 based on at least one of the color of the dog, the shapes of the dog's ears, eyes, mouth and nose and the positions of the dog's ears, eyes, mouth and nose.

The controller 200 may vary contents displayed on the display module 110 according to the object (the dog's breed). For example, when the object identifier 210 identifies DOG1, the controller 200 may display DOG1's usual favorite content on the display module 110. For example, when the object identifier 210 identifies DOG2, the controller 200 may display DOG2's usual favorite content on the display module 110.

The object identifier 210 may identify the dog's breed and age. The controller 200 may vary the contents displayed on the display module 110 based on the dog's breed and age.

For example, when the dog identified by the object identifier 210 is not a dog stored in a database, the object identifier 210 may provide customized content based on the dog's breed and age.

The controller 200 may further include an approaching determiner 220 determining the dog's approach based on data of the proximity sensor 130.

For example, when a distance between the dog and the display module is less than a first distance for equal to or greater than a first time, the approaching determiner may determine the dog's approach. When the distance between the dog and the display module is greater than a second distance which is greater than the first distance for equal to or greater than a second time which is greater than the first time, the approaching determiner may determine that the dog leaves. Herein, for example, the first distance may be 50 cm and the second distance may be 1 m. In addition, the first time may be five minutes and the second time may be twenty minutes. Compared to conditions for determining an approach stage, conditions for determining a leaving state may be managed more strictly. When the leaving state of the dog is determined, the display module 110 may be turned off to reduce the power consumption of the display apparatus 100 for a dog.

The controller 200 may further include a viewing determiner 230 determining whether the dog views a video or not based on data of the camera 120.

The viewing determiner 230 may detect positions of eyes of the dog (eye detection), set a region of interest (ROI) at the positions of the eyes of the dog and operate an eye tracking based on the region of interest. The viewing determiner 230 may determine the dog's visual attention allocation, gaze position and gaze movement using the eye tracking and determine whether the dog is concentrating on the video based on the dog's visual attention allocation, gaze position and gaze movement.

For example, the viewing determiner 230 may determine whether the dog views a video or not using artificial intelligence algorithms such as a machine learning, a deep learning and so on. For example, the dog's viewing immersion state is learned based on the dog's static image or the dog's moving image. And then, when the dog is recognized by the camera 120, the viewing determiner 230 may automatically determine the dog's viewing immersion state information.

The controller 200 may further include an emotion recognizer 240 determining the dog's emotion based on data of the camera 120. Alternatively, the emotion recognizer 240 may determine the dog's emotion based on the data of the camera 120 and data of the microphone 140.

For example, the emotion recognizer 240 may determine the dog's positive emotion and the dog's negative emotion using movements of the dog's ears and movements of the dog's facial muscles.

For example, the emotion recognizer 240 may determine the dog's positive emotion and the dog's negative emotion using angles of the dog's ears, eyes, mouth and nose and shapes of eyes.

The emotion recognizer 240 may determine a degree of the dog's fatigue based on a degree of the dog's eyelid closure and a degree of the dog's mouth opening. When the degree of the dog's eyelid closure is great, the emotion recognizer 240 may determine the degree of the dog's fatigue is great. When the degree of the dog's mouth opening is great, the emotion recognizer 240 may determine that the dog yawns. When the number of the dog's yawns is high, the emotion recognizer 240 may determine the degree of the dog's fatigue is great.

For example, the emotion recognizer 240 may determine the dog's positive emotion, the dog's negative emotion and the degree of the dog's fatigue using artificial intelligence algorithms such as a machine learning, a deep learning and so on. For example, the dog's emotion state is learned based on the dog's static image or the dog's moving image. And then, when the dog is recognized by the camera 120, the emotion recognizer 240 may automatically determine the dog's emotion state information.

In an embodiment of the present inventive concept, the display module 110, the sensor 120, 130, 140 and 150 may be included in the display apparatus. The sensor 120, 130, 140 and 150 may be internal sensors of the display apparatus 100 for a dog.

Alternatively, the sensor may be the external sensors 300 disposed outside the display apparatus 100 for a dog. For example, the external sensors 300 include an imaging apparatus 310 and a sound recording apparatus 320 in FIG. 6. The external sensors 300 may include the above-mentioned camera, the proximity sensor and the microphone. The external sensors 300 may be disposed in at least one of a laptop computer, a personal computer, an internet television and a closed circuit camera system.

The interactive display system for a dog may operate using the internal sensors of the display apparatus 100 for a dog, and the external sensors included in various electronic apparatuses (e.g. the laptop computer, the personal computer, the internet television, the closed circuit camera system and so on) which is disposed outside the display apparatus 100 for a dog.

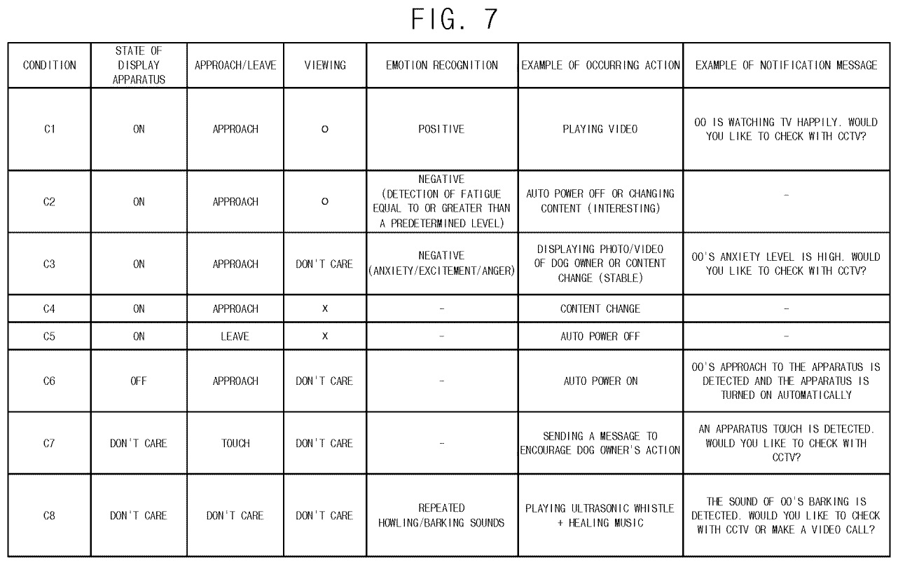

FIG. 7 is a table illustrating an example of an operation of the interactive display system for a dog of FIG. 2.

Referring to FIGS. 1 to 7, for example, when the approaching determiner 220 determines that the dog is in a close distance, the viewing determiner 230 determines that the dog is viewing the video and the emotion recognizer 240 determines the dog's positive emotion (condition C1), the controller 200 may control the display module 110 to display the video continuously.

In addition, when the approaching determiner 220 determines that the dog is in a close distance, the viewing determiner 230 determines that the dog is viewing the video and the emotion recognizer 240 determines the dog's positive emotion (condition C1), the controller 200 may send a notification message to the dog owner's mobile apparatus 500 indicating that the dog is viewing the video with the positive emotion.

For example, when the approaching determiner 220 determines that the dog is in a close distance, the viewing determiner 230 determines that the dog is viewing the video and the emotion recognizer 240 determines that the degree of the dog's fatigue is equal to or greater than a reference value (condition C2), the controller 200 may control to turn off the display module 110 or to change a content of the display module 110.

For example, when the approaching determiner 220 determines that the dog is in a close distance and the emotion recognizer 240 determines that the dog is asleep, the controller 200 may control to turn off the display module 110.

For example, when the approaching determiner 220 determines that the dog is in a close distance and the emotion recognizer 240 determines the dog's negative emotion (condition C3), the controller 200 may control the display module 110 to display a photo or a video of the dog owner to calm the dog's emotion. For example, the photo or the video of the dog owner may be stored in the memory 400.

For example, when the approaching determiner 220 determines that the dog is in a close distance and the emotion recognizer 240 determines the dog's negative emotion (condition C3), the controller 200 may control to change a content of the display module 110 to calm the dog's emotion. In this case, the changed content may include the dog's usual favorite video or a food video. For example, the dog's usual favorite video may be stored in the memory 400.

In addition, when the approaching determiner 220 determines that the dog is in a close distance and the emotion recognizer 240 determines the dog's negative emotion (condition C3), the controller 200 may send a notification message to the dog owner's mobile apparatus 500 indicating that the dog has the negative emotion.

The memory 400 may store the content displayed on the display module 110 by tagging the dog's viewing status for the content. Accordingly, the content which the dog was immersed in watching may be distinguished and the content which the dog was immersed in watching may be inferred as the content which the dog likes.

The memory 400 may store the content displayed on the display module 110 by tagging the dog's emotion for the content. Accordingly, the content which the dog expressed the positive emotion may be distinguished and the content which the dog expressed the positive emotion may be inferred as the content which the dog likes.

The content inferred as the content which the dog likes in this way may be used as a recommended content or a calming content for the same dog or dogs having the same breed.

When the approaching determiner 220 determines that the dog is in a close distance and the viewing determiner 230 determines that the dog is not viewing the video (condition C4), the controller 200 may control to change a content of the display module 110.

When the approaching determiner 220 determines that the dog is not in a close distance and the viewing determiner 230 determines that the dog is not viewing the video (condition C5), the controller 200 may control to turn off the display module 110. Thus, the power consumption of the display apparatus may be reduced.

When the approaching determiner 220 determines that the dog is in a close distance while the display module 110 is turned off (condition C6), the controller 200 may control to turn on the display module 110. When the display module 110 is automatically turned on, the controller 200 may send a notification message to the dog owner's mobile apparatus 500 notifying that the display module 110 is automatically turned on.

In addition, the shock sensor 150 detects a shock (condition C7), the controller 200 may send a notification message to the dog owner notifying a shock detection to encourage the dog owner's action.

For example, when the controller 200 recognizes that the barking or howling sound is repeated multiple times by the microphone 140 (condition C8), the controller 200 may control to play a whistle sound or play a calming content.

Herein, the calming content may be a healing music. Alternatively, the calming content may be the photo or the video of the dog owner. Alternatively, the calming content may be the content which the dog was immersed in watching or the content which the dog expressed the positive emotion.

In addition, when the controller 200 recognizes that the barking or howling sound is repeated multiple times by the microphone 140 (condition C8), the controller 200 may send a sound generation notification message to the dog owner's mobile apparatus 500.

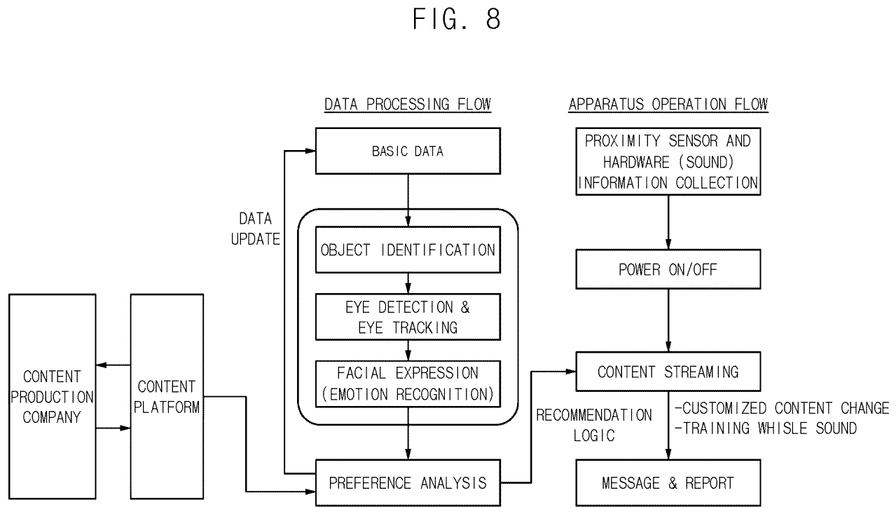

FIG. 8 is a flowchart diagram illustrating an example of an operation sequence of the interactive display system for a dog of FIG. 2.

Referring to FIGS. 1 to 8, a data processing flow of the interactive display system for a dog may include identifying the object based on basic data (by the object identifier 210), determining whether the dog views the video or not using the eye detection and the eye tracking (by the viewing determiner 230) and recognizing the dog's emotion by analyzing the dog's facial expressions and the dog's behavior (by the emotion recognizer 240) while the dog is watching the video. Herein, the basic data may include profile images for dogs, reference data for determining emotional state for dog breeds and so on. The basic data may be used in a step of identifying the object, a step of determining whether the dog views the video or not and a step of recognizing the dog's emotion.

The data processing flow of the interactive display system for a dog may operate a preference analysis for the dog based on whether the dog views the video or not and the dog's emotion.

The controller 200 may receive contents from a content platform provided by a content production company and may operate content recommendation corresponding to a result of the preference analysis. In addition, the controller 200 may update the basic data based on the result of the preference analysis.

In addition, the controller 200 may transmit the result of the preference analysis to the content platform so that the controller 200 may provide customization information about content to be subsequently received.

The content platform may continuously recommend and provide appropriate content for each individual (dog breed, dog age) using an individual result of the preference analysis.

As shown in an apparatus operation flow of the interactive display system for a dog, the interactive display system for a dog may collect the dog's proximity information and the dog's sound information through the proximity sensor 130 and the microphone 140.

When it is determined that dog is in a close distance from the display module 110 by the dog is in a close distance, the display module 110 and the camera 120 of the display apparatus 100 for a dog may be automatically turned on. Although the proximity sensor 130 and the microphone 140 are turned on in advance, the present inventive concept may not be limited thereto. Alternatively, the dog's proximity information and the dog's sound information may be determined by the external sensor 300.

When the camera 120 of the display apparatus 100 for a dog is turned on, the object identification, the eye detection, the eye tracking and the emotion recognition may be operated. The content according to the result of the preference analysis may be displayed by the display apparatus 100 for a dog (content streaming). As exemplified referring to FIG. 7, the content may include the content to attract the dog's interest, the photo of the dog owner, the video of the dog owner, the content to calm the dog, the training whistle sound, and the healing music. The content may not be a video specifically prepared for dogs, but may be a general television video or a YouTube video.

As shown in the apparatus operation flow of the interactive display system for a dog, as exemplified referring to FIG. 7, the controller 200 may transmit various notification messages to the dog owner's mobile apparatus 500 notifying the dog's status (the dog's condition). The dog owner may control the operation of the apparatuses for the corresponding circumstances through the mobile apparatus 500.

In addition, the controller 200 may transmit an analysis report regarding the displayed content, the dog's behaviors, states and emotions according to the displayed content to the dog owner's mobile apparatus 500.

According to the present embodiment, the operation of the display system may be controlled according to the dog's approach to the display module 110. In addition, the operation of the display system may be controlled according to whether the dog views the video on the display module 100. In addition, the operation of the display system may be controlled according to the change of the dog's emotion in response to the displayed video.

In addition, the display system may be controlled based on the dog's approach, whether the dog views the video, or the dog's emotion so that the dog's concentration may be increased and a power consumption of the display system may be reduced.

In addition, a notification may be sent to the dog owner's mobile apparatus 500 based on the dog's approach, whether the dog views the video, the dog's emotion or the dog's barking sound so that the dog owner may remotely control the display system based on the notification.

In addition, the object may be identified so that the customized content according to the object (e.g. a dog's breed) may be provided.

In addition, whether the dog views the video and the dog's emotion for the content displayed on the display module 110 may be stored in the memory and used for subsequent content recommendations.

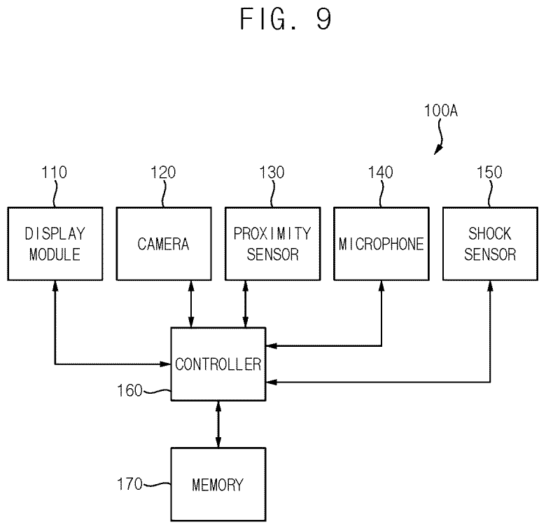

FIG. 9 is a block diagram illustrating an interactive display apparatus 100A for a dog according to an embodiment of the present inventive concept.

In the present embodiment, the display module 110, the sensor 120, 130, 140 and 150, the controller 160 and the memory 170 may be included in the display apparatus 100A for a dog.

Referring to FIG. 9, the interactive display apparatus 100A for a dog includes the display module 110, the sensor 120, 130, 140 and 150, the controller 160 and the memory 170.

The controller 160 may control an operation of the display module 110 by determining at least one of the dog's approach, whether the dog views the video, and the dog's emotion based on sensed data of the sensor 120, 130, 140 and 150.

The operation of the controller 160 of FIG. 9 may be substantially the same as the operation of the control apparatus 200 of FIG. 2. The operation of the memory 170 of FIG. 9 may be substantially the same as the operation of the memory 400 of FIG. 2.

### INDUSTRIAL AVAILABILITY

The present inventive concept may be applied to the display apparatus for a dog and an electronic apparatus including the display apparatus. For example, the present inventive concept may be applied to a TV, a digital TV, a 3D TV, a cellular phone, a smart phone, a tablet PC, a VR apparatus, a PC, a home electronic apparatus, a laptop, a PDA, a PMP, a digital camera, a music player, a portable game console, a navigation, a sensor and a wearable sensor and so on.

Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims.

<EXPLANATION OF REFERENCE NUMBERS>

| | |
|---|---|
| 100, 100A: DISPLAY | 110: DISPLAY MODULE |
| APPARATUS FOR A DOG | |
| 120: CAMERA | 130: PROXIMITY SENSOR |
| 140: MICROPHONE | 150: SHOCK SENSOR |
| 160: CONTROLLER | 170: MEMORY |
| 200: CONTROL APPARATUS | 210: OBJECT IDENTIFIER |
| 220: APPROACHING DETERMINER | 230: VIEWING DETERMINER |
| 240: EMOTION RECOGNIZER | 300: EXTERNAL SENSOR |
| 310: IMAGING APPARATUS | 320: SOUND RECORDING |
| | APPARATUS |
| 400: MEMORY | 500: MOBILE APPARATUS |

1. An interactive display system for a dog comprising:
a display module which displays an image;
a sensor which senses the dog's condition; and
a controller which determines at least one of the dog's approach, whether the dog views a video and the dog's emotion based on sensed data of the sensor and which controls an operation of the interactive display system.

2. The interactive display system for a dog of claim 1, wherein the controller comprises an object identifier which identifies an object based on the sensed data.

3. The interactive display system for a dog of claim 2, wherein the sensor comprises a camera which senses an appearance of the dog, and
wherein the object identifier identifies the object based on at least one of a color of the dog, shapes of the dog's ears, eyes, mouth and nose and positions of the dog's ears, eyes, mouth and nose.

4. The interactive display system for a dog of claim 3, wherein the controller varies contents displayed on the display module according to the object.

5. The interactive display system for a dog of claim 3, wherein the object identifier identifies the dog's breed and age.

6. The interactive display system for a dog of claim 5, wherein the controller varies contents displayed on the display module based on the dog's breed and age.

7. The interactive display system for a dog of claim 1, wherein the sensor comprises a proximity sensor, and wherein the controller comprises an approaching determiner which determines the dog's approach based on data of the proximity sensor.

8. The interactive display system for a dog of claim 7, wherein when a distance between the dog and the display module is less than a first distance for equal to or greater than a first time, the approaching determiner determines the dog's approach, and
wherein when the distance between the dog and the display module is greater than a second distance which is greater than the first distance for equal to or greater than a second time which is greater than the first time, the approaching determiner determines that the dog leaves.

9. The interactive display system for a dog of claim 7, wherein the sensor comprises a camera, and
wherein the controller comprises a viewing determiner which determines whether the dog views the video or not based on data of the camera.

10. The interactive display system for a dog of claim 9, wherein the viewing determiner sets a region of interest at positions of eyes of the dog and operates an eye tracking based on the region of interest.

11. The interactive display system for a dog of claim 9, wherein the controller further comprises an emotion recognizer which determines the dog's emotion based on the data of the camera.

12. The interactive display system for a dog of claim 11, wherein the sensor further comprises a microphone, and
wherein the emotion recognizer determines the dog's emotion based on the data of the camera and data of the microphone.

13. The interactive display system for a dog of claim 11, wherein the emotion recognizer determines the dog's positive emotion and the dog's negative emotion using movements of the dog's ears and movements of the dog's facial muscles.

14. The interactive display system for a dog of claim 11, wherein the emotion recognizer determines the dog's positive emotion and the dog's negative emotion using angles of the dog's ears, eyes, mouth and nose and shapes of eyes.

15. The interactive display system for a dog of claim 11, wherein when the approaching determiner determines that the dog is in a predetermined distance, the viewing determiner determines that the dog is viewing the video and the emotion recognizer determines the dog's positive emotion, the controller controls the display module to display the video continuously.

16. The interactive display system for a dog of claim 15, wherein when the approaching determiner determines that the dog is in the predetermined distance, the viewing determiner determines that the dog is viewing the video and the emotion recognizer determines the dog's positive emotion, the controller sends a notification message to a dog owner's mobile apparatus notifying that the dog is viewing the video with the positive emotion.

17. The interactive display system for a dog of claim 11, wherein the emotion recognizer determines a degree of the dog's fatigue based on a degree of the dog's eyelid closure and a degree of the dog's mouth opening.

18. The interactive display system for a dog of claim 11, wherein when the approaching determiner determines that the dog is in a predetermined distance, the viewing determiner determines that the dog is viewing the video and the emotion recognizer determines that the degree of the dog's fatigue is equal to or greater than a reference value, the controller controls to turn off the display module or to change a content of the display module.

19. The interactive display system for a dog of claim 11, wherein when the approaching determiner determines that the dog is in a predetermined distance and the emotion recognizer determines the dog's negative emotion, the controller controls the display module to display a photo or a video of a dog owner.

20. The interactive display system for a dog of claim 11, wherein when the approaching determiner determines that the dog is in a predetermined distance and the emotion recognizer determines the dog's negative emotion, the controller controls to change a content of the display module.

21. The interactive display system for a dog of claim 11, wherein when the approaching determiner determines that the dog is in a predetermined distance and the emotion recognizer determines the dog's negative emotion, the controller sends a notification message to a dog owner's mobile apparatus notifying that the dog has the negative emotion.

22. The interactive display system for a dog of claim 11, further comprising a memory which stores a content displayed on the display module by tagging the dog's emotion for the content.

23. The interactive display system for a dog of claim 9, wherein when the approaching determiner determines that the dog is in a predetermined distance and the viewing determiner determines that the dog is not viewing the video, the controller controls to change a content of the display module.

24. The interactive display system for a dog of claim 9, wherein when the approaching determiner determines that the dog is not in a predetermined distance and the viewing determiner determines that the dog is not viewing the video, the controller controls to turn off the display module.

25. The interactive display system for a dog of claim 9, further comprising a memory which stores a content displayed on the display module by tagging the dog's viewing status for the content.

26. The interactive display system for a dog of claim 5, wherein when the approaching determiner determines that the dog is in a predetermined distance while the display module is turned off, the controller controls to turn on the display module.

27. The interactive display system for a dog of claim 1, wherein the sensor comprises a shock sensor, and
wherein when the shock sensor detects a shock, the controller sends a notification message to a dog owner notifying a shock detection.

28. The interactive display system for a dog of claim 1, wherein the sensor comprises a microphone, and
wherein when the controller recognizes that a barking sound or a howling sound is repeated multiple times by the microphone, the controller controls to play a whistle sound or play a calming content.

29. The interactive display system for a dog of claim 1, wherein the sensor comprises a microphone, and
wherein when the controller recognizes that a barking sound or a howling sound is repeated multiple times by the microphone, the controller sends a sound generation notification message to a dog owner's mobile apparatus.

30. The interactive display system for a dog of claim 1, wherein the display module and the sensor are included in a display apparatus,
wherein the sensor is an internal sensor of the display apparatus, and
wherein the sensor comprises a camera, a proximity sensor and a microphone.

31. The interactive display system for a dog of claim 1, wherein the display module is included in a display apparatus, and
wherein the sensor is an external sensor disposed outside the display apparatus.

32. The interactive display system for a dog of claim 31, wherein the external sensor is disposed in at least one of a laptop computer, a personal computer, an internet television and a closed circuit camera system.

33. A method of operating an interactive display system for a dog, the method comprising:
displaying an image;
sensing the dog's condition; and
controlling an operation of the interactive display system using at least one of the dog's approach, whether the dog views the video and the dog's emotion determined based on sensed data of a sensor.

34. An interactive display system for a dog comprising:
a display module;
a sensor; and
a controller which determines at least one of the dog's approach, whether the dog views a video and the dog's emotion based on sensed data of the sensor and which controls an operation of the display module.
